(19) United States
(12) Patent Application Publication
(10) Pub. No.: US 2025/0294346 A1
(43) Pub. Date: Sep. 18, 2025

(54) BATCH EXCHANGE OF ROAMING REQUESTS

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 19/057,896

(22) Filed: Feb. 19, 2025

Related U.S. Application Data
(60) Provisional application No. 63/565,396, filed on Mar. 14, 2024.

(51) Int. Cl. H04W 12/0471; H04L 9/30; H04W 12/041

(52) U.S. Cl. CPC H04W 12/0471; H04L 9/3073; H04W 12/041

(57) ABSTRACT

The present disclosure describes an access point that batches roaming requests and responses. The access point includes one or more memories and one or more processors communicatively coupled to the one or more memories. The one or more processors, individually or collectively, perform an operation that includes receiving, from a device, a message comprising (i) a first portion indicating a first target access point and (ii) a second portion indicating a second target access point, based on the first portion indicating the first target access point, communicating, to the first target access point, a first instruction to generate a first pairwise transient key (PTK) for communicating with the device, and based on the second portion indicating the second target access point, communicating, to the second target access point, a second instruction to generate a second PTK for communicating with the device.

### CROSS-REFERENCE TO RELATED APPLICATIONS

This application claims benefit of co-pending U.S. provisional patent application Ser. No. 63/565,396 filed Mar. 14, 2024. The aforementioned related patent application is herein incorporated by reference in its entirety.

### TECHNICAL FIELD

Embodiments presented in this disclosure generally relate to wireless communications (e.g., Wi-F communication). More specifically, embodiments disclosed herein relate to the batch exchange of roaming requests.

### BACKGROUND

Seamless roaming is used in wireless networks (e.g., Wi-Fi networks) to reduce transition times and delays when roaming between access points. Many network deployments today use a technique called Fast BSS Transition (FT) to roam between access points. During FT, a client device may exchange roaming requests and responses with several candidate access points. These exchanges, however, create significant overhead and traffic for the network. Additionally, these exchanges introduce delay to the FT process.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example network controller, access point, or device of the system of FIG. 1A.

FIG. 2 illustrates an example operation performed by the system of FIG. 1A.

FIG. 3 illustrates an example message.

FIG. 4 illustrates an example operation performed by the system of FIG. 1A.

FIG. 5 illustrates an example instruction.

FIG. 6 is a flowchart of an example method performed by the system of FIG. 1A.

FIG. 7 illustrates an example operation performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes an access point that batches roaming requests and responses. According to an embodiment, an access point includes one or more memories and one or more processors communicatively coupled to the one or more memories. The one or more processors, individually or collectively, perform an operation that includes receiving, from a device, a message comprising (i) a first portion indicating a first target access point and (ii) a second portion indicating a second target access point, based on the first portion indicating the first target access point, communicating, to the first target access point, a first instruction to generate a first pairwise transient key (PTK) for communicating with the device, and based on the second portion indicating the second target access point, communicating, to the second target access point, a second instruction to generate a second PTK for communicating with the device.

According to another embodiment, a method includes receiving, from a device, a message comprising (i) a first portion indicating a first target access point and (ii) a second portion indicating a second target access point, based on the first portion indicating the first target access point, communicating, to the first target access point, a first instruction to generate a first PTK for communicating with the device, and based on the second portion indicating the second target access point, communicating, to the second target access point, a second instruction to generate a second PTK for communicating with the device.

According to another embodiment, a non-transitory computer readable medium stores instructions that, when executed by one or more processors, cause the one or more processors to, individually or collectively, perform an operation that includes receiving, from a device, a message comprising (i) a first portion indicating a first target access point and (ii) a second portion indicating a second target access point, based on the first portion indicating the first target access point, communicating, to the first target access point, a first instruction to generate a first PTK for communicating with the device, and based on the second portion indicating the second target access point, communicating, to the second target access point, a second instruction to generate a second PTK for communicating with the device.

### Example Embodiments

The present disclosure describes a wireless network (e.g., a Wi-Fi network) that uses batch roaming requests and responses. For example, when a client device in the network is performing FT roaming, the client device may communicate a batch request to an access point. The batch request may indicate multiple candidate access points. The access point may then generate individual requests to the candidate access points so that these access points may establish pairwise transient keys (PTKs) for communicating with the client device. The candidate access points may communicate responses to these individual requests back to the access point. The access point then generates a batch response using these individual responses and communicates the batch response to the client device. The client device may then generate PTKs for communicating with the candidate access points before the client device roams to one of the candidate access points.

In certain embodiments, the wireless network provides several technical advantages. For example, the wireless network may reduce overhead during FT roaming by using the batch request and the batch response, instead of having the client device exchange requests and responses with the candidate access points. As another example, the wireless network may reduce delays during FT roaming by using the batch request and batch response.

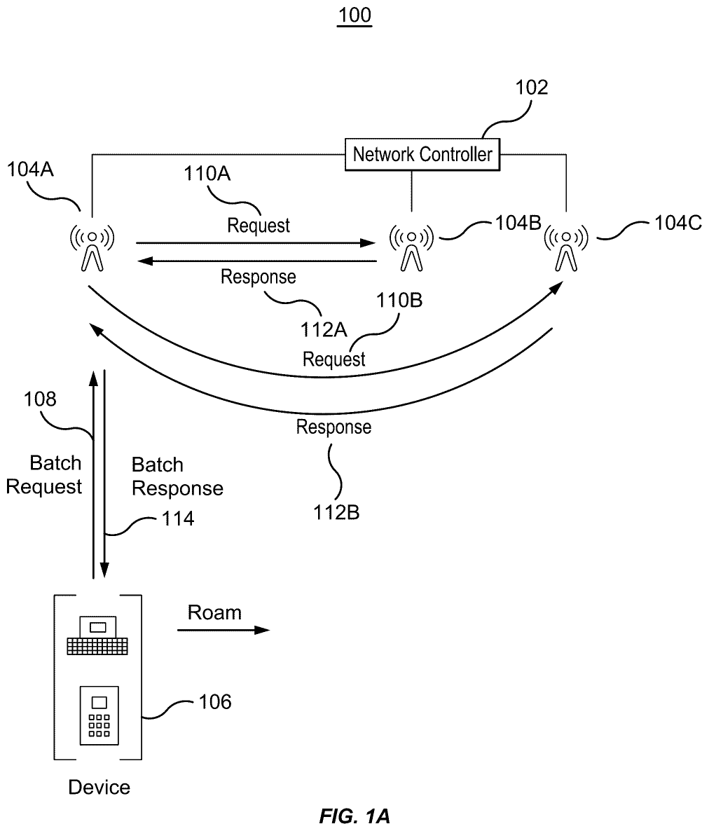

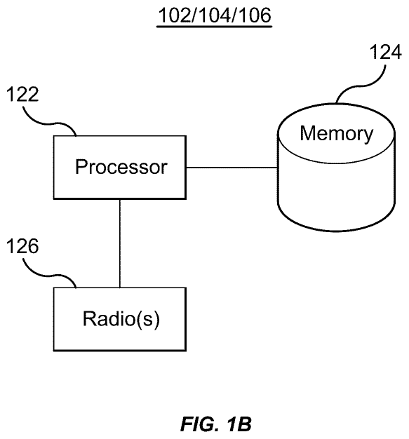

FIG. 1A illustrates an example system 100, which may be a network deployment that provides wireless communication (e.g., Wi-Fi communications). As seen in FIG. 1A, the system 100 includes a network controller 102, multiple access points 104, and a device 106 (which may also be referred to as a client device). Generally, the device 106 performs a batch exchange of roaming requests when performing FT roaming.

The network controller 102 facilitates or manages the communication in the system 100. As an example, the network controller 102 may facilitate the generation of the keys (e.g., pairwise master keys (PMKs) and pairwise transient keys (PTKs)) used by the access points 104 and the device 106 to communicate with each other. The network controller 102 may generate and store a PMK (which may also be referred to as PMK-R0). The network controller may use PMK-R0 to generate PMKs for the access points 104 (each referred to as PMK-R1). Each access point 104 then uses a PMK-R1 to establish a PTK for encrypting and decrypting communications with the device 106. In some embodiments, the network controller 102 is a network device separate from the access points 104 and the device 106. In other embodiments, the network controller 102 is deployed in an access point 104 or distributed across several access points 104.

The access point 104 may be a network device that facilitates wireless communication (e.g., Wi-Fi communication) in the system 100. In the example of FIG. 1, the system 100 includes an access point 104A, an access point 104B, and an access point 104C. The device 106 connects to the access point 104A, and the access point 104A my facilitate communication to and from the device 106. For example, the access point 104A may receive messages from the device 106 and direct those messages towards their destination. As another example, the access point 104A may receive messages intended for the device 106 and direct those messages to the device 106. The access point 104A may also exchange messages with the network controller 102 and/or with the access points 104B and 104C.

The device 106 may be any suitable device that wirelessly connects to an access point 104. As an example and not by way of limitation, the device 106 may be a computer, a laptop, a wireless or cellular telephone, an electronic notebook, a personal digital assistant, a tablet, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment usable by the user. The device 106 may include a hardware processor, memory, or circuitry configured to perform any of the functions or actions of the device 106 described herein. For example, a software application designed using software code may be stored in the memory and executed by the processor to perform the functions of the device 106.

The device 106 may typically connect to a first access point 104 (e.g., access point 104A) that is closest to the device 106. As the device 106 moves in the system 100, the device 106 may determine that communications could be improved if the device 106 roams to another access point 104 in the system 100. To reduce the amount of time that it takes to roam to another access point 104, the device 106 may establish PTKs for communicating with the device 106 on multiple candidate access points 104 in advance of the roam. As a result, when the device 106 roams to one of the candidate access points 104, the candidate access point 104 will have already established a PTK for encrypting and decrypting communications with the device 106. As discussed above, in existing networks, a device establishes the PTKs on the candidate access points by performing exchanges with the candidate access points, which creates significant overhead and traffic for the network. Additionally, these exchanges introduce delay to the roaming process.

In the system 100, the device 106 establishes the PTKs on candidate access points 104 using a batch exchange. In the example of FIG. 1A, the device 106 is connected with the access point 104A, and the device 106 considers the access points 104B and 104C as candidates for roaming. The device 106 communicates a batch request 108 to the access point 104A to establish PTKs on the access points 104B and 104C. The batch request 108 may identify the access points 104B and 104C, and the batch request 108 may include information (e.g., nonce values) that may be used by the access points 104B and 104C to generate or establish PTKs.

The access point 104A receives the batch request 108 and uses the information in the batch request 108 to generate requests 110 for each of the access points 104B and 104C. For example, the access point 104A generates the request 110A for the access point 104B and the request 110B for the access point 104C. The request 110A may identify the device 106 and may include the information (e.g., a nonce value) that the access point 104B uses to generate a PTK. The request 110B may identify the device 106 and may include the information (e.g., a nonce value) that the access point 104C uses to generate a PTK. The access point 104A communicates the requests 110A and 110C to the access point 104B and 104C (e.g., over-the-air or over-the-distribution system (DS)).

The access points 104B and 104C use the information in the requests 110A and 110B, respectively, to generate PTKs for communicating with the device 106. For example, the access points 104B and 104C may each use a PMK-R1 from the network controller 102 and a nonce value in the request 110A or 110B to generate a PTK. After establishing the PTKs, the access points 104B and 104C communicate responses 112 to the access point 104A. The access point 104B generates and communicates a response 112A to the access point 104A, and the access point 104C generates and communicates a response 112B to the access point 104A. The responses 112A and 112B may include information (e.g., nonce values) that the device 106 may use to establish PTKs for communicating with the access points 104B and 104C.

The access point 104A receives the responses 112A and 112B and uses the information in the responses 112A and 112B to generate a batch response 114. The batch response 114 may identify the access points 104B and 104C and may include the information in the responses 112A and 112B (e.g., nonce values). The access point 104A then communicates the batch response 114 to the device 106. The device 106 may use the information in the batch response 114 to generate PTKs for communicating with the access points 104B and 104C. In this manner, the device 106 and the access points 104B and 104C establish PTKs for communicating with each other before the device 106 roams to either of the access points 104B or 104C. By using the batch request 108 and the batch response 114, the device 106 avoids performing exchanges with the candidate access points, which reduces the overhead and traffic in the network in certain embodiments.

FIG. 1B illustrates an example network controller 102, access point 104, or device 106 of the system of FIG. 1A. As seen in FIG. 1B, the network controller 102, access point 104, and/or device 106 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the network controller 102, access point 104, and/or device 106. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the network controller 102, access point 104, and/or device 106 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the network controller 102, access point 104, and/or device 106 may use one or more of the radios 126 for Wi-Fi communications. The network controller 102, access point 104, and/or device 106 may use one or more of the radios 126 to transmit messages and one or more of the radios 126 to receive messages. The network controller 102, access point 104, and/or device 106 may include any number of radios 126 to communicate using any number of communication technologies.

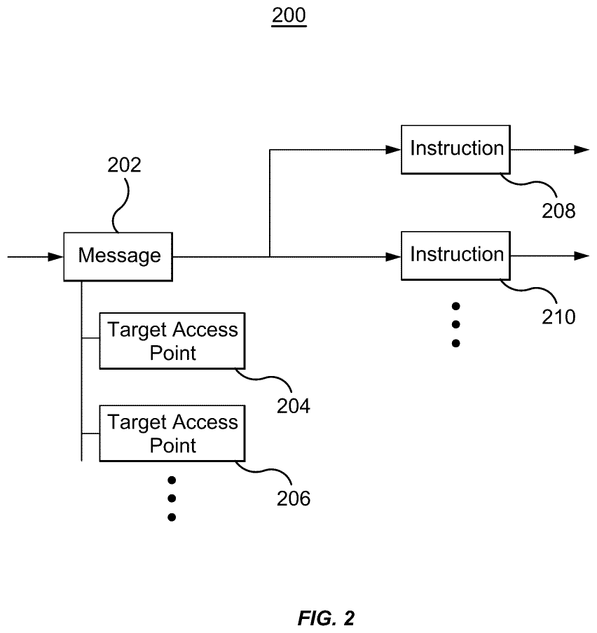

FIG. 2 illustrates an example operation 200 performed by the system 100 of FIG. 1A. Generally, an access point (e.g., the access point 104A shown in FIG. 1A) performs the operation 200. By performing the operation 200, the access point handles and processes a batch instruction.

The access point begins by receiving a message 202. The message 202 may be generated and communicated by a device (e.g., the device 106 shown in FIG. 1A) to the access point. The message 202 may be a batch request indicating multiple access points to which the device may roam. In the example of FIG. 2, the message 202 indicates a target access point 204 and a target access point 206. The message 202 may include any identifiers for the target access points 204 and 206. For example, the message 202 may include names, network addresses, media access control (MAC) addresses, and/or other identifiers of the target access points 204 and 206. Generally, the message 202 indicates that the device is considering roaming to one of the target access points 204 and 206 and that PTKs should be established on the target access points 204 and 206.

The access point generates instructions for the target access points identified in the message 202. The instructions may instruct the target access points to establish PTKs for communicating with the device. Additionally, the instructions may include information that the target access points may use to establish the PTKs. For example, the instructions may identify the device that generated the message 202 and nonce values that the target access points may use to establish PTKs for communicating with the device. In the example of FIG. 2, the access point generates the instructions 208 and 210 for the target access points 204 and 206. The instruction 208 may include information from the message 202 that the target access point 204 may use to establish a PTK for communicating with the device, and the instruction 210 may include information from the message 202 that the target access point 206 may use to establish a PTK for communicating with the device. The access point communicates the instructions 208 and 210 to the target access points 204 and 206, respectively, to instruct the target access points 204 and 206 to establish the PTKs. The access point may communicate the instructions 208 and 210 to the target access points 204 and 206 over-the-air or over-the-DS.

Each member in the message 202 may be listed as: (i) a traditional 802.11 element (e.g., element identifier, length, data; or element identifier, length, element identifier extension, data), (ii) a traditional 802.11 element with member content fragmentation across multiple elements if there is greater than 255/254 octets of member content; and the start of a fresh member is indicated via some internal protocol (e.g., first data octet indicates if this is the start of continuation of the member content), (iii) a type-length-value (e.g., with 2 octets of length), (iv) a length-type-value (e.g., with 1 or 2 octets of length), or (v) a length-value (e.g., with 1 or 2 octets of length, as long as only one type of member content needs to be sent). An element or type-length-value may further include sub-elements/fields/subfields for the member content. The message 202 may contain multiple such members in one of the formats listed above.

The message 202 may also use one of the following formats: (i) Count+CommonLength (e.g., as 1 or 2 octets)+N*(member content fields each of size CommonLength), (ii) Count+N*(Length (e.g., as 1 or 2 octets)+member content fields of size Length size), or (iii) Count+N*standardized-length fields. The Count may indicate the number of members included in the message 202.

In some embodiments, the access point (or a network controller operating on behalf of the access point) may apply policy and filter the message 202 to determine whether to send instructions to the target access points indicated by the message 202. For example, the access point may filter out certain target access points based on processing times, network delays, crash rates, whether the target access points are overloaded or about to shut down, etc. The access point may then refrain from sending instructions to those target access points in response to the message 202. As a result, the access point may send instructions to some, but not all, of the target access points indicated by the message 202.

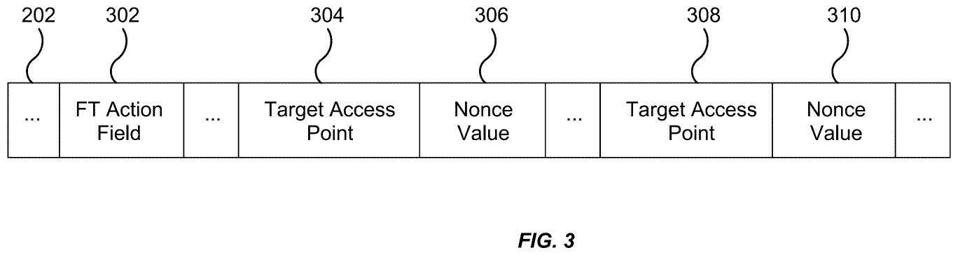

FIG. 3 illustrates an example message 202. Generally, the message 202 may be a batch request communicated by a device (e.g., the device 106 shown in FIG. 1A) to an access point (e.g., the access point 104A shown in FIG. 1A). The message 202 may identify any number of target access points and may include nonce values or other information for any number of target access points. The device that generated the message 202 may aggregate the identifiers and the information for the target access points into one message 202. The device may then communicate the message 202 to the access point. The access point may use the information in the message 202 to generate instructions for the target access points identified in the message 202.

As seen in FIG. 3, the message 202 includes a field 302 that may be referred to as an FT Action Field. The field 302 may include a value that indicates that the message 202 is a batch request for establishing PTKs on multiple target access points. Additionally, the value of the field 302 may indicate that the message 202 identifies multiple target access points and includes information for the multiple target access points. In some embodiments, the message 202 includes an additional field (e.g., a length or count field) that indicates the number of target access points identified by the message 202.

In the example of FIG. 3, the message 202 includes a field 304 that includes an identifier for a first target access point. For example, the field 304 may include a name, network address, MAC address, or other identifier for the first target access point. The message 202 also includes a field 306 that includes a first nonce value (which may be referred to as an SNonce) for the first target access point. The first target access point may use the first nonce value to establish a PTK for communicating with the device. Additionally, the message 202 includes a field 308 that includes an identifier for a second target access point. For example, the field 308 may include a name, network address, MAC address, or other identifier for the second target access point. The message 202 also includes a field 310 that includes a second nonce value (which may be referred to as an SNonce) for the second target access point. The second target access point may use the second nonce value to establish a PTK for communicating with the device.

In some embodiments, the message 202 includes fields indicating public keys. For example, the message 202 may include a field that includes a first public key for the first target access point and a field that includes a second public key for the second target access point. These public keys may have been generated by or provided to the device that generated the message 202. For example, the public keys may be part of private/public key pairs that the device may use to encrypt communications with the first and second target access points. In some instances, the first public key and the second public key may be the same (e.g., match).

When the access point receives the message 202, the access point may generate instructions for the target access points using the information in the message 202. Each instruction may include information from the message 202 (e.g., a nonce value, a public key, etc.) intended for a particular target access point. In this manner, the access point splits or divides the message 202 into individual instructions for the target access points. The access point communicates the instructions to the target access points, and the target access points use the information in their respective instructions (e.g., nonce values, public keys, etc.) to establish PTKs for communicating with the device.

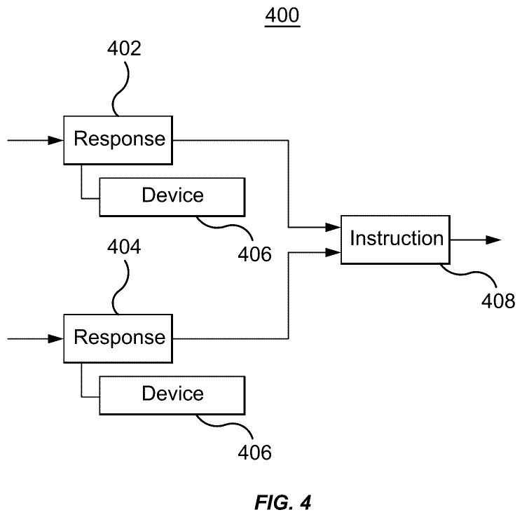

FIG. 4 illustrates an example operation 400 performed by the system 100 of FIG. 1A. Generally, an access point (e.g., the access point 104A shown in FIG. 1A) performs the operation 400. By performing the operation 400, the access point receives responses to a batch request from target access points, and the access point aggregates the information in the responses to form a batch response to the batch request.

The access point begins by receiving responses 402 and 404 from target access points. The responses 402 and 404 may be communicated to the access point from different target access points, and the responses 402 and 404 may be responses to instructions (e.g., the instructions 208 and 210 shown in FIG. 2) previously communicated by the access point to the target access points. The target access points may have established PTKs for communicating with a device (e.g., the device 106 shown in FIG. 1A) using the information in the instructions (e.g., nonce values) and other information (e.g., PMK-R1). The target access points then generate the responses 402 and 404, which indicate that the target access points successfully established the PTKs. The responses 402 and 404 may also include other information (e.g., nonce values) that the device may use to establish PTKs for communicating with the target access points. The target access points communicate the responses 402 and 404 to the access point, and the access point aggregates the information in the responses 402 and 404 to form a batch response for the device.

As seen in FIG. 4, the response 402 and 404 identify a device 406 for which the information in the responses 402 and 404 is intended. For example, the responses 402 and 404 may include a name, network address, MAC address, or other identifier for the device 406. The device 406 may be the device 406 that originally generated the batch request. The access point determines from the response 402 and 404 identifying the same device 406 that the access point should aggregate the information in the responses 402 and 404. The access point generates an instruction 408 by aggregating the information in the responses 402 and 404. For example, the instruction 408 may identify the target access points that generated the responses 402 and 404. Additionally, the instruction 408 may include nonce values (which may be referred to as ANonces) provided by the target access points and/or public keys provided by the target access points. The access point may communicate the instruction 408 to the device 406 to respond to the batch request previously communicated by the device 406. The device 406 may then establish PTKs for communicating with the target access points identified in the instruction 408 using the information (e.g., nonce values, public keys, etc.) in the instruction 408. Thus, the instruction 408 serves as the batch response for the batch request previously communicated by the device 406.

In this manner, the access point uses a batch request from the device to establish PTKs on multiple target access points for communicating with the device and uses a batch response to instruct the device to establish PTKs for communicating with the multiple target access points. As a result, the device avoids exchanging requests with individual target access points, which reduces network overhead and traffic in certain embodiments. Additionally, by using the batch request and batch response, delay in establishing the PTKs may be reduced.

In certain embodiments, the PTKs generated by the device for communicating with the target access points are the same as (e.g., matches) the PTKs generated by the corresponding target access points for communicating with the device. For example, the same information may be used to generate the PTKs on the target access points and the device.

In some embodiments, a target access point may provide a reject response (e.g., indicating that the device should not connect to the target access point). In response, the access point may indicate in the instruction 408 that the device should not roam to the target access point (e.g., by including the reject response in the instruction 408). Alternatively, the access point may leave information about the target access point out of the instruction 408.

In some instances, different target access points may have different software processing times, different network delays, crash rates, etc. As a result, the access point may receive responses from different target access points at different times, and/or the access point may fail to receive responses from some target access points. The access point may generate and communicate the instruction 408 using responses from less than all of the target access points indicated in the initial batch request. If the access point receives a response from a target access point subsequent co communicating the instruction 408, the access point may generate and communicate another instruction that includes information from the response from that target access point. If the access point does not receive a response from a target access point, the access point may indicate in the instruction 408 that no response was received from the target access point.

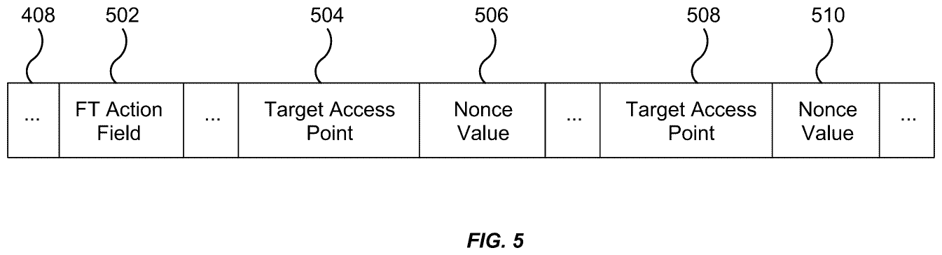

FIG. 5 illustrates an example instruction 408. Generally, the instruction 408 may be a batch response communicated by an access point (e.g., the access point 104A shown in FIG. 1A) to a device (e.g., the device 106 shown in FIG. 1A). The instruction 408 may identify any number of target access points and may include nonce values or other information from any number of target access points. The access point may aggregate the identifiers and the information from the target access points into one instruction 408. The access point may then communicate the instruction 408 to the device. The device may use the information in the instruction 408 to establish PTKs for encrypting and decrypting communications with the target access points identified in the instruction 408.

As seen in FIG. 5, the instruction 408 includes a field 502 that may be referred to as an FT Action Field. The field 502 may include a value that indicates that the instruction 408 is a batch response for establishing PTKs on the device for communicating with multiple target access points. Additionally, the value of the field 502 may indicate that the instruction 408 identifies multiple target access points and includes information from the multiple target access points. In some embodiments, the instruction 408 includes an additional field (e.g., a length or count field) that indicates the number of target access points identified by the instruction 408.

In the example of FIG. 5, the instruction 408 includes a field 504 that includes an identifier for a first target access point. For example, the field 504 may include a name, network address, MAC address, or other identifier for the first target access point. The instruction 408 also includes a field 306 that includes a first nonce value (which may be referred to as an ANonce) from the first target access point. The device may use the first nonce value to establish a PTK for communicating with the first target access point. Additionally, the instruction 408 includes a field 508 that includes an identifier for a second target access point. For example, the field 508 may include a name, network address, MAC address, or other identifier for the second target access point. The instruction 408 also includes a field 510 that includes a second nonce value (which may be referred to as an ANonce) from the second target access point. The device may use the second nonce value to establish a PTK for communicating with the second target access point.

In some embodiments, the instruction 408 includes fields indicating public keys. For example, the instruction 408 may include a field that includes a first public key from the first target access point and a field that includes a second public key from the second target access point. These public keys may have been generated by or provided to the first and second target access points. For example, the public keys may be part of private/public key pairs that the first and second target access points may use to encrypt communications with the device. The device may use the public keys indicated in the instruction 408 to generate PTKs for communicating with the target access points.

The access point may generate the instruction 408 after receiving responses from the target access points. The target access points may have generated the responses after establishing PTKs for communicating with the device. The access point may aggregate the information in the responses to form the instruction 408. As a result, the instruction 408 may include information (e.g., nonce values, public keys, etc.) that the device may use to establish PTKs for communicating with the target access points. The access point communicates the instruction 408 to the device, and the device uses the information in the instruction 408 to establish PTKs for communicating with the target access points.

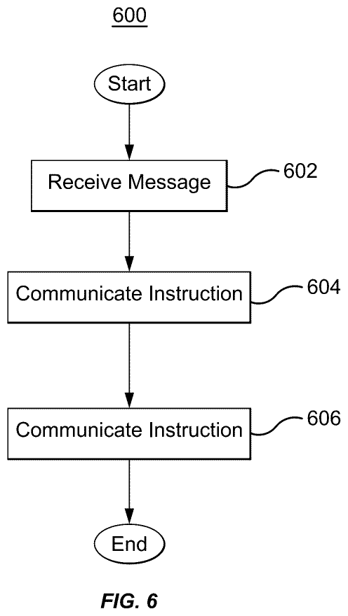

FIG. 6 is a flowchart of an example method 600 performed by the system 100 of FIG. 1A. In particular embodiments, an access point (e.g., the access point 104A shown in FIG. 1A) performs the method 600. By performing the method 600, the access point generates instructions for multiple target access points based on a batch request from a device.

At 602, the access point receives a message from a device. The message may be a batch request for multiple target access points to establish PTKs for communicating with the device. The message may identify these target access points. Additionally, the message may include other information (e.g., nonce values) that the target access points may use to establish the PTKs.

At 604, the access point communicates a first instruction to a first target access point identified by the message. The access point may generate the first instruction using information in the message. For example, the access point may determine that the message identifies the first target access point. In response, the access point may retrieve the information from the message that is intended for the first target access point (e.g., a nonce value that the first target access point should use to establish a PTK for communicating with the device). The access point then generates the first instruction for the first target access point. The access point may include the information for the first target access point in the first instruction.

At 606, the access point communicates a second instruction to a second target access point identified by the message. The access point may generate the second instruction using information in the message. For example, the access point may determine that the message identifies the second target access point. In response, the access point may retrieve the information from the message that is intended for the second target access point (e.g., a nonce value that the second target access point should use to establish a PTK for communicating with the device). The access point then generates the second instruction for the second target access point. The access point may include the information for the second target access point in the second instruction.

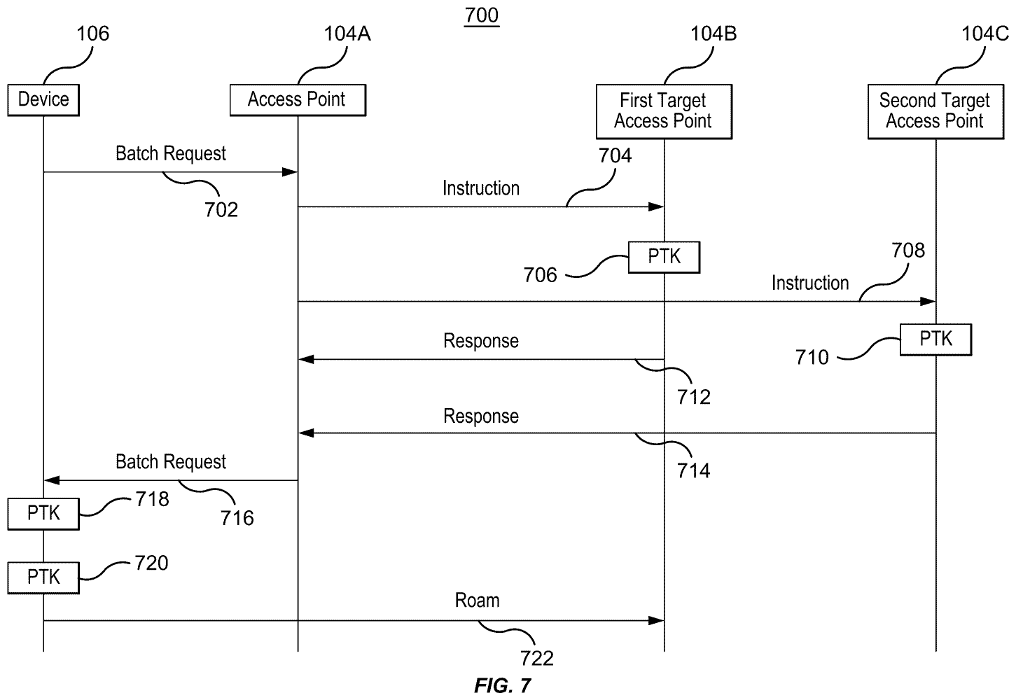

FIG. 7 illustrates an example operation 700 performed by the system 100 of FIG. 1A. Generally, different components of the system 100 perform the operation 700. By performing the operation 700, the system 100 reduces the amount of overhead and traffic involved in establishing PTKs on multiple target access points.

As seen in FIG. 7, the device 106 begins by communicating a batch request to the access point 104A at 702. The batch request may identify multiple target access points, such as the first target access point 104B and the second target access point 104C. The device 106 may communicate the batch request 702 to indicate that the target access points should prepare for the device 106 roaming to the target access points by establishing PTKs for communicating with the device 106. In some embodiments, the batch request also includes SNonces that the target access points may use to establish the PTKs.

At 704, the access point 104A generates and communicates an instruction to the first target access point 104B. This instruction may identify the device 106 and may include the SNonce for the first target access point 104B provided in the batch request 702. The first target access point 104B receives this instruction and generates or establishes a PTK 706 for communicating with the device 106 using the information (e.g., the SNonce) included in the instruction. The access point may communicate the instruction over-the-air or over-the-DS.

At 708, the access point 104A generates and communicates an instruction to the second target access point 104C. This instruction may identify the device 106 and may include the SNonce for the second target access point 104C provided in the batch request 702. The second target access point 104C receives this instruction and generates or establishes a PTK 710 for communicating with the device 106 using the information (e.g., the SNonce) included in the instruction. The access point may communicate the instruction over-the-air or over-the-DS.

At 712, the first target access point 104B generates and communicates a response to the access point 104A. This response may identify the device 106 and may include information (e.g., an ANonce) that the device 106 may use to establish a PTK for communicating with the first target access point 104B. At 714, the second target access point 104C generates and communicates a response to the access point 104A. This response may identify the device 106 and may include information (e.g., an ANonce) that the device 106 may use to establish a PTK for communicating with the second target access point 104C. The first target access point 104B may communicate the response over-the-air or over-the-DS.

At 716, the access point 104A aggregates the information in the responses from the first target access point 104B and the second target access point 104C to form a batch response. The access point 104A then communicates the batch response to the device 106. The access point 104A may generate the batch response in response to determining that the responses from the first target access point 104B and the second target access point 104C identify the device 106. The batch response may identify the first target access point 104B and the second target access point 104C, and the batch response may include the ANonces provided by the first target access point 104B and the second target access point 104C. The second target access point 104C may communicate the response over-the-air or over-the-DS.

The device 106 establishes PTKs 718 and 720 for communicating with the first target access point 104B and the second target access point 104C using the information (e.g., ANonces) in the batch response. For example, the device 106 may establish the PTK 718 using the ANonce in the batch response that was provided by the first target access point 104B, and the device 106 may establish the PTK 720 using the ANonce in the batch response that was provided by the second target access point 104C. After establishing the PTKs 718 and 720, the device 106 may determine that the device 106 should roam to the first target access point 104B. The device 106 may then roam to the first target access point 104B (e.g., associate with the first target access point 104B) at 722. The device 106 may use the PTK 718 to encrypt and decrypt communications with the first target access point 104B, and the first target access point 104B may use the PTK 706 to encrypt and decrypt communications with the device 106. In this manner, the device 106 uses the batch request and the batch response to establish PTKs with the first target access point 104B and the second target access point 104C before the device 106 roams to or associates with the first target access point 104B or the second target access point 104C.

In some embodiments, the batch request described above may also be used for batch sending other frames to multiple neighboring access points via the serving access point. For example, the batch request may be used by a device to batch send multiple probe request frames in a batch probe request to multiple neighboring access points over-the-DS through the serving access point and to receive probe responses from those neighboring access points. The serving access point will collect probe responses from multiple neighboring access points over-the-DS and send a batch probe response to the device.

In certain embodiments, the batch request described above may be used by a device to batch send (re)association request frames to multiple neighboring access points over-the-DS to create hot standby associations with those neighboring access points. Batch (re)association request/response frames can be used for this. The device can then activate one of those (re)association at a later point in time based on the signal strength observed.

In summary, the present disclosure describes a wireless network (e.g., a Wi-Fi network) that uses batch roaming requests and responses. For example, when a client device in the network is performing FT roaming, the client device may communicate a batch request to an access point 104. The batch request may indicate multiple target access points. The access point 104 may then generate individual requests to the target access points so that these access points may establish pairwise transient keys (PTKs) for communicating with the client device. The target access points may communicate responses to these individual requests back to the access point 104. The access point 104 then generates a batch response using these individual responses and communicates the batch response to the client device. The client device may then generate PTKs for communicating with the target access points before the client device roams to one of the target access points.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
one or more memories; and
one or more processors communicatively coupled to the one or more memories, the one or more processors configured to, individually or collectively, perform an operation comprising:
receiving, from a device, a message comprising (i) a first portion indicating a first target access point and (ii) a second portion indicating a second target access point;
based on the first portion indicating the first target access point, communicating, to the first target access point, a first instruction to generate a first pairwise transient key (PTK) for communicating with the device; and
based on the second portion indicating the second target access point, communicating, to the second target access point, a second instruction to generate a second PTK for communicating with the device.

2. The access point of claim 1, wherein the message indicates (i) at least one of a first nonce value or a first public key and (ii) at least one of a second nonce value or a second public key, wherein the first PTK is generated based on at least one of the first nonce value or the first public key, and wherein the second PTK is generated based on at least one of the second nonce value or the second public key.

3. The access point of claim 2, wherein the first public key matches the second public key.

4. The access point of claim 1, wherein the operation further comprises:
receiving, from the first target access point, a first response indicating the device;
receiving, from the second target access point, a second response indicating the device; and
communicating, to the device and based on the first response and the second response, a third instruction to generate a third PTK for communicating with the first target access point and to generate a fourth PTK for communicating with the second target access point.

5. The access point of claim 4, wherein the first response indicates at least one of a first nonce value or a first public key and the second response indicates at least one of a second nonce value or a second public key, wherein the third instruction indicates (i) at least one of the first nonce value or the first public key and (ii) at least one of the second nonce value or the second public key, wherein the third PTK is generated based on at least one of the first nonce value or the first public key, and wherein the fourth PTK is generated based on at least one of the second nonce value or the second public key.

6. The access point of claim 4, wherein the message further comprises a third portion indicating a third target access point, and wherein the operation further comprises:
based on the third portion indicating the third target access point, communicating, to the third target access point, a third instruction to generate a fifth PTK for communicating with the device;
receiving, from the third target access point and after communicating the third instruction to the device, a third response indicating the device; and
communicating, to the device and based on the third response, a fourth instruction to generate a sixth PTK for communicating with the third target access point.

7. The access point of claim 4, wherein the first PTK matches the third PTK, and wherein the second PTK matches the fourth PTK.

8. The access point of claim 4, wherein the message further comprises a third portion indicating a third target access point, and wherein the operation further comprises:
based on the third portion indicating the third target access point, communicating, to the third target access point, a third instruction to generate a fifth PTK for communicating with the device; and
receiving, from the third target access point, a reject response indicating that the device should not connect to the third target access point, wherein the third instruction comprises the reject response.

9. The access point of claim 1, wherein the message comprises a third portion indicating that the message comprises a batch request.

10. The access point of claim 1, wherein the first instruction and the second instruction are communicated to the first target access point and the second target access point prior to the device associating with the first target access point or the second target access point.

11. The access point of claim 1, wherein the message comprises a network address of the first target access point and a network address of the second target access point.

12. The access point of claim 1, wherein the message further comprises a third portion indicating a third target access point, and wherein the operation further comprises:
determining, based on filtering the message, that the device should not connect to the third target access point; and
based on determining that the device should not connect to the third target access point, refrain from communicating, to the third target access point, a third instruction to generate a third PTK for communicating with the device.

13. A method comprising:
receiving, from a device, a message comprising (i) a first portion indicating a first target access point and (ii) a second portion indicating a second target access point;
based on the first portion indicating the first target access point, communicating, to the first target access point, a first instruction to generate a first PTK for communicating with the device; and
based on the second portion indicating the second target access point, communicating, to the second target access point, a second instruction to generate a second PTK for communicating with the device.

14. The method of claim 13, wherein the message indicates (i) at least one of a first nonce value or a first public key and (ii) at least one of a second nonce value or a second public key, wherein the first PTK is generated based on at least one of the first nonce value or the first public key, and wherein the second PTK is generated based on at least one of the second nonce value or the second public key.

15. The method of claim 13, further comprising:
receiving, from the first target access point, a first response indicating the device;
receiving, from the second target access point, a second response indicating the device; and
communicating, to the device and based on the first response and the second response, a third instruction to generate a third PTK for communicating with the first target access point and to generate a fourth PTK for communicating with the second target access point.

16. The method of claim 15, wherein the first response indicates at least one of a first nonce value or a first public key and the second response indicates at least one of a second nonce value or a second public key, wherein the third instruction indicates (i) at least one of the first nonce value or the first public key and (ii) at least one of the second nonce value or the second public key, wherein the third PTK is generated based on at least one of the first nonce value or the first public key, and wherein the fourth PTK is generated based on at least one of the second nonce value or the second PTK.

17. The method of claim 13, wherein the message comprises a third portion indicating that the message comprises a batch request.

18. The method of claim 13, wherein the first instruction and the second instruction are communicated to the first target access point and the second target access point prior to the device associating with the first target access point or the second target access point.

19. The method of claim 13, wherein the message comprises a network address of the first target access point and a network address of the second target access point.

20. A device comprising:
one or more memories; and
one or more processor communicatively coupled to the one or more memories, wherein the one or more processors are configured to, individually or collectively, perform an operation comprising:
determining a first target access point and a second target access point as candidates for roaming;
based on determining the first target access point and the second target access point, generating a message comprising (i) a first portion indicating the first target access point and (ii) a second portion indicating the second target access point;
communicating the message to a serving access point different from the first target access point and the second target access point;
receiving, from the serving access point, an instruction; and
generating a first PTK and a second PTK based on the instruction.
